(19) United States
(12) Patent Application Publication
(10) Pub. No.: US 2025/0136068 A1
(43) Pub. Date: May 1, 2025

(54) AXLE ASSEMBLY HAVING A DRIVE PINION BRAKE

(71) Applicant: ArvinMeritor Technology, LLC, Troy, MI (US)

(72) Inventor: Gregory Pavuk, Troy, MI (US)

(73) Assignee: ArvinMeritor Technology, LLC, Troy, MI (US)

(21) Appl. No.: 18/496,563

(22) Filed: Oct. 27, 2023

(51) Int. Cl. B60T 1/06; B60B 35/12; B60B 35/16; B60K 1/00; B60K 17/16; F16D 55/22; F16H 48/42; F16H 57/02; F16H 57/037

(52) U.S. Cl. CPC B60T 1/062; B60B 35/125; B60B 35/16; B60K 1/00; B60K 17/165; F16H 48/42; F16H 57/037; B60K 2001/001; F16D 55/22; F16H 2057/02034; F16H 2057/02052

(57) ABSTRACT

An axle assembly comprising a differential carrier, a differential assembly, a drive pinion, and a drive pinion brake. The drive pinion brake is mounted to the differential carrier. The differential carrier supports the differential assembly. The drive pinion brake is operable to apply a brake torque to inhibit rotation of the drive pinion.

### TECHNICAL FIELD

This relates to an axle assembly that has a drive pinion brake. The drive pinion brake may provide parking brake functionality.

### BACKGROUND

An axle assembly having a differential brake is disclosed in U.S. patent application Ser. No. 17/713,317.

### SUMMARY

The invention relates to an axle assembly. The axle assembly comprises a differential carrier, a differential assembly, a drive pinion, and a drive pinion brake. The differential assembly is rotatably mounted to the differential carrier. The differential assembly is rotatable about a differential axis. The drive pinion is rotatable about a drive pinion axis. The drive pinion axis differs from the differential axis. The drive pinion is operatively connectable to the differential assembly. The drive pinion brake is mounted to the differential carrier. The drive pinion brake is operable to apply a brake torque. The brake torque inhibits rotation of the drive pinion about the drive pinion axis.

The brake torque may inhibit rotation of the differential assembly.

The differential axis may be disposed substantially parallel to the drive pinion axis. The differential axis may not intersect the drive pinion axis. The drive pinion axis may be disposed below the differential axis.

The axle assembly may further comprise an axle housing. The axle housing may be mounted to the differential carrier. The axle housing and the differential carrier may cooperate to define a cavity. The differential assembly may be disposed inside the cavity. The drive pinion brake may not be mounted to the axle housing.

The differential assembly may further comprise a ring gear. The drive pinion may further comprise a gear portion. The gear portion may not mesh with the ring gear.

The axle assembly may further comprise an intermediate shaft. The intermediate shaft may be rotatable about an intermediate shaft axis. The intermediate shaft may further comprise a first intermediate gear. The first intermediate gear may mesh with the drive pinion. The intermediate shaft may further comprise a second intermediate gear. The second intermediate gear may mesh with the ring gear. The intermediate shaft may be rotatably supported on the differential carrier. The intermediate shaft axis may not intersect the differential axis. The intermediate shaft axis may not intersect the drive pinion axis.

The drive pinion brake may be disposed outside the differential carrier. The drive pinion brake may further comprise a rotatable braking component. The rotatable braking component may be rotatable about the drive pinion axis with the drive pinion. The rotatable braking component may further comprise a friction surface.

The drive pinion brake may have a friction member. The friction member may be engageable with the friction surface to provide the brake torque. The friction member may be positioned further from the differential axis than the drive pinion axis is positioned from the differential axis. The friction member may be disposed above the drive pinion axis.

The drive pinion brake may be configured as a disc brake. The rotatable braking component may be a brake rotor.

The drive pinion may have a shaft portion. The shaft portion may extend through an opening in the differential carrier. The rotatable braking component may be mounted to the shaft portion.

The drive pinion may be operatively connectable to a torque source. The torque source may be an electric motor. The drive pinion may further comprise a gear portion. The gear portion may be positioned along the drive pinion axis between the electric motor and the drive pinion brake.

### BRIEF DESCRIPTION OF THE DRAWINGS

FIG. 1 is a perspective view of an example of an axle assembly.

FIG. 2 is a side view of the axle assembly of FIG. 1 with wheel hubs and wheel brake assemblies omitted for clarity.

FIG. 3 is a perspective view of a portion of the axle assembly of FIG. 1 with the axle housing and associated components removed for clarity.

FIG. 4 is a section view along section line 4-4.

FIG. 5 is a section view along section line 5-5.

FIG. 6 is a perspective view of an example of a drive pinion brake that may be provided with the axle assembly.

FIG. 7 is a perspective view of a portion of the drive pinion brake of FIG. 6.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It will also be understood that, although the terms first, second, etc. are, in some instances, used herein to describe various elements, these elements should not be limited by these terms. These terms are only used to distinguish one element from another. For example, a first element could be termed a second element, and similarly a second element could be termed a first element without departing from the scope of the various described embodiments. The first element and the second element are both elements, but they are not the same element.

The terminology used in the description of the various described embodiments is for the purpose of describing particular embodiments only and is not intended to be limiting. As used in the description of the various described embodiments and the appended claims, the singular forms “a” and “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

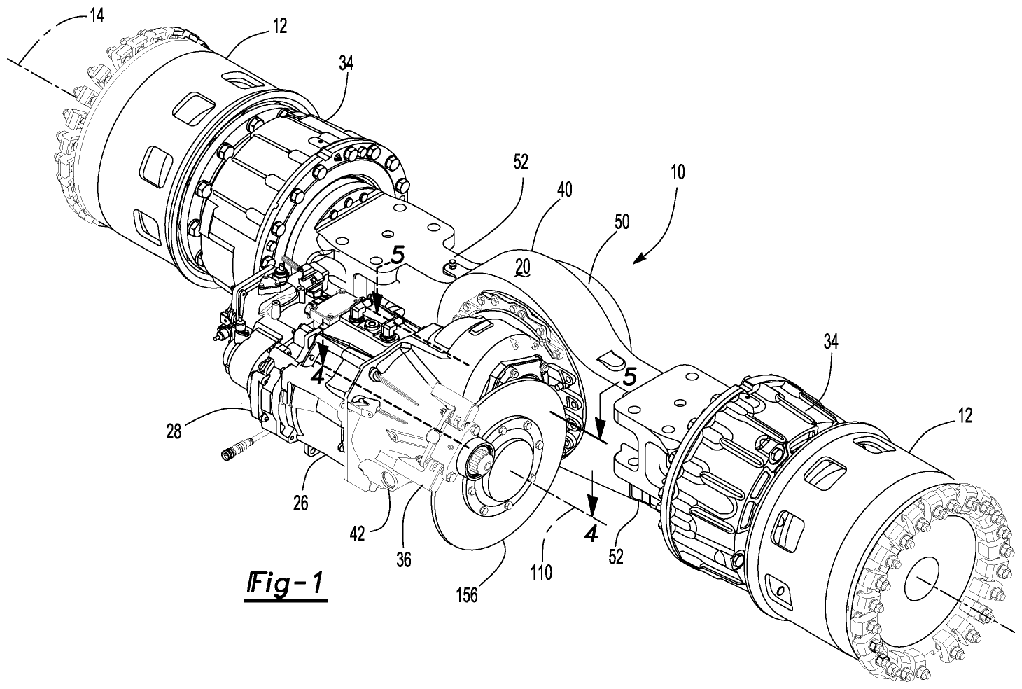

Referring to FIG. 1, an example of an axle assembly 10 is shown. The axle assembly 10 may be provided with a motor vehicle like a truck, bus, farm equipment, mining equipment, military transport or weaponry vehicle, or cargo loading equipment for land, air, or marine vessels. The motor vehicle may include a trailer for transporting cargo in one or more embodiments. One or more axle assemblies may be provided with the vehicle.

The axle assembly 10 is configured to provide torque to one or more traction wheel assemblies that may include a tire mounted on a wheel. A wheel is mountable to a wheel hub 12 that may be rotatable about a wheel axis 14.

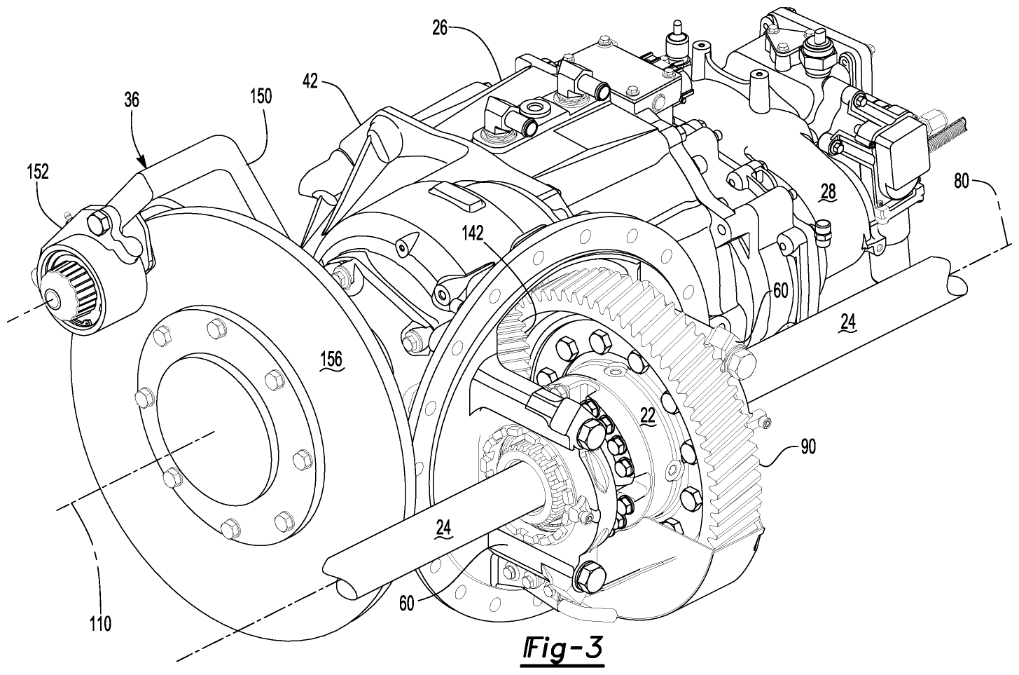

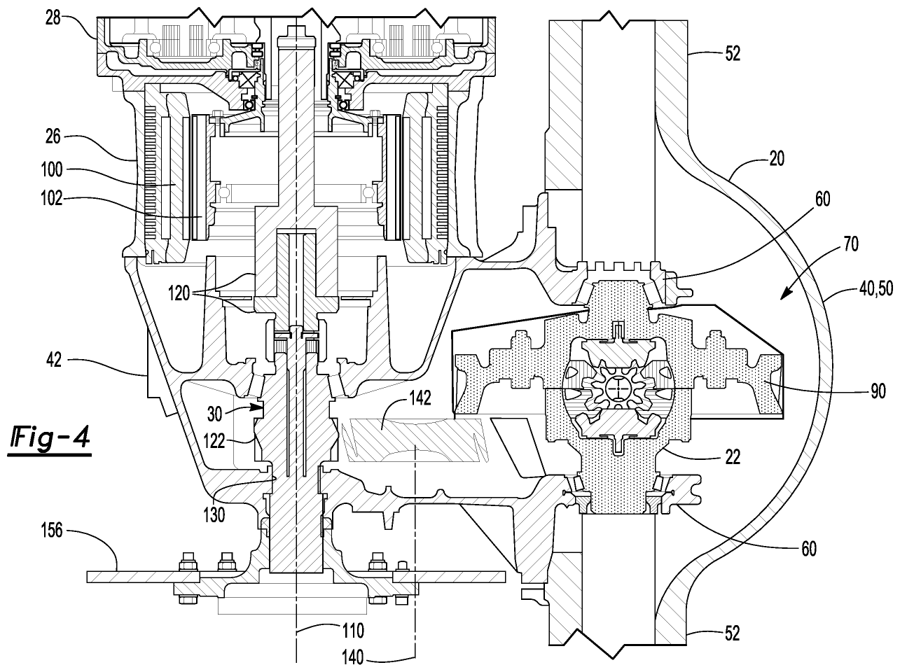

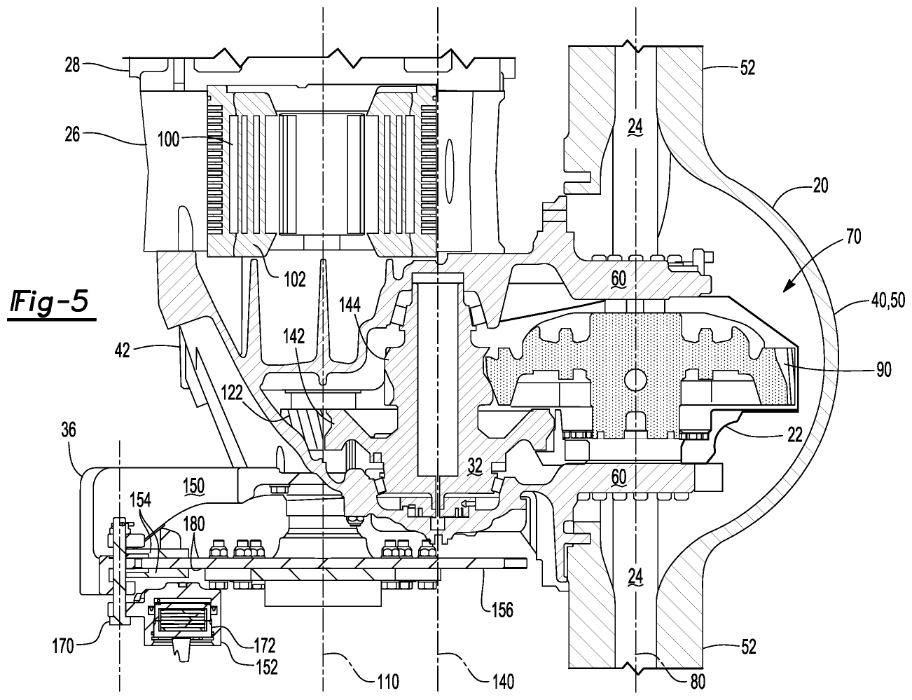

As is best shown with reference to FIGS. 1 and 3, the axle assembly 10 includes a housing assembly 20, a differential assembly 22, and at least one axle shaft 24. The axle assembly 10 may also include or may be connected to a torque source 26. In some configurations, the axle assembly 10 includes a transmission 28, a drive pinion 30 (an example of which is best shown in FIG. 4), an intermediate shaft 32 (an example of which is best shown in FIG. 5), and one or more wheel brake assemblies 34. The axle assembly 10 also includes a drive pinion brake 36.

Referring to FIG. 1, the housing assembly 20 receives various components of the axle assembly 10. In addition, the housing assembly 20 facilitates mounting of the axle assembly 10 to the vehicle. In some configurations, the housing assembly 20 includes an axle housing 40 and a differential carrier 42.

The axle housing 40 receives and supports the axle shafts 24. Examples of axle shafts 24 are best shown in FIG. 3 with the axle housing 40 omitted for clarity. Referring primarily to FIGS. 1 and 4, the axle housing 40 may include a center portion 50 and at least one arm portion 52.

The center portion 50 may be disposed proximate the center of the axle housing 40. A lower region of the center portion 50 may at least partially define a sump portion that may contain or collect lubricant.

One or more arm portions 52 may extend from the center portion 50. For example, two arm portions 52 may extend in opposite directions from the center portion 50 and away from the differential assembly 22. The arm portions 52 may have similar configurations. For example, the arm portions 52 may each have a hollow configuration or tubular configuration that may extend around and may receive a corresponding axle shaft 24 and may help separate or isolate the axle shaft 24 or a portion thereof from the surrounding environment. Each arm portion 52 may support a wheel hub 12 and a wheel brake assembly 34 that is configured to brake the wheel hub 12 and hence brake a wheel that is mounted to the wheel hub 12.

Referring primarily to FIGS. 1 and 3-5, the differential carrier 42 is mounted to the axle housing 40. For instance, the differential carrier 42 may be mounted to the center portion 50 of the axle housing 40 with fasteners such as bolts. In some configurations, the differential carrier 42 interconnects the axle housing 40 to the torque source 26. The differential carrier 42 supports the differential assembly 22. For example, the differential carrier 42 may include one or more bearing supports 60 that may support a bearing like a roller bearing assembly that may rotatably support the differential assembly 22. As is best shown in FIGS. 4 and 5, the differential carrier 42 and the center portion 50 of the axle housing 40 may cooperate to at least partially define a cavity 70 that receives the differential assembly 22 or inside which the differential assembly 22 is disposed.

Referring primarily to FIGS. 3 and 5, the differential assembly 22 is rotatably mounted to or rotatably disposed on the differential carrier 42. The differential assembly 22 is rotatable about a differential axis 80. The differential assembly 22 is configured to transmit torque between the torque source 26 and the axle shafts 24. The differential assembly 22 is operatively connected to or is operatively connectable to the axle shafts 24 and may permit the axle shafts 24 to rotate at different rotational speeds in a manner known by those skilled in the art. The differential assembly 22 may include a ring gear 90 that may have teeth that may be arranged around the differential axis 80.

The axle shafts 24 transmit torque between the differential assembly 22 and the wheel hubs 12, which are best shown in FIG. 1. For instance, each axle shaft 24 may transmit torque between the differential assembly 22 and a corresponding wheel hub 12. As an example, an axle shaft 24 may have a first end and a second end. The first end may be operatively connected to the differential assembly 22. The second end may be disposed opposite the first end and may be operatively connected to a corresponding wheel hub 12. Two axle shafts 24 may be provided such that each axle shaft 24 extends through a different arm portion 52 of axle housing 40. The axle shafts 24 may extend along and may be rotatable about an axis, such as the wheel axis 14 or the differential axis 80. The wheel axis 14 and the differential axis 80 may or may not be coaxially disposed depending on the configuration of the axle assembly 10. Gear reduction may be provided between an axle shaft 24 and a wheel.

Referring primarily to FIGS. 1 and 4, the torque source 26 may be provided with the axle assembly 10 or may be connected to the axle assembly 10. The torque source 26 is configured to provide torque to the differential assembly 22 via the transmission 28 and intervening components such as a drive pinion 30 and intermediate shaft 32, which will be discussed in more detail below.

The torque source 26 may be of any suitable type, such as an electric motor, an internal combustion engine, or combinations thereof. In the configuration shown, the torque source 26 is illustrated as being an electric motor that is mounted to the differential carrier 42. The electric motor is configured to provide torque, such as propulsion torque or regenerative braking torque. Propulsion torque may be used to propel the vehicle, such as in a forward or backward direction. Propulsion torque may also be used to hold the vehicle in a stationary position or to help reduce, limit, or prevent vehicle rollback, such as when the vehicle is on an inclined surface. Regenerative braking may provide a regenerative braking torque. Regenerative braking may capture kinetic energy when the electric motor is used to brake or slow the velocity of the vehicle. Recovered energy may be transmitted from the wheels and wheel hubs 12 to drive the electric motor. Thus, the electric motor may function as a generator and may be used to charge an electric power source, such as a battery. The electric motor may be electrically connected to the electric power source via an inverter in a manner known by those skilled in the art.

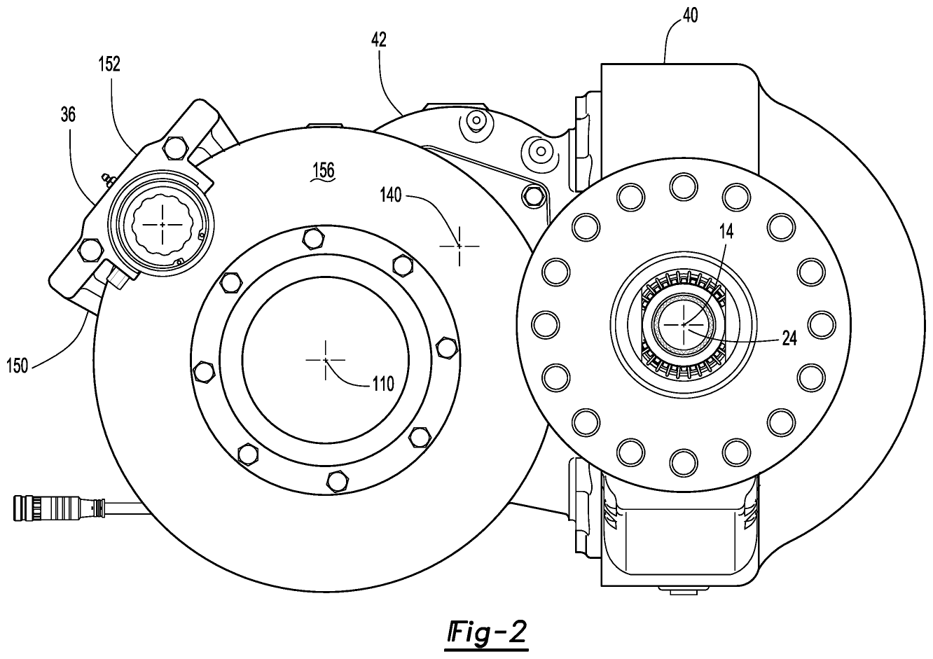

As is best shown in FIG. 4, an electric motor may include a stator 100 and a rotor 102. The stator 100 may be fixedly positioned in a motor housing, which may be part of the housing assembly 20. The stator 100 may encircle the rotor 102. The rotor 102 is rotatable about an axis 110 with respect to the stator 100. The axis 110 may be referred to as a rotor axis, or drive pinion axis. The axis 110 differs from the differential axis 80, which is best shown in FIG. 5. For instance, the differential axis 80 may not intersect the axis 110 and be disposed substantially parallel to the differential axis 80. The term “substantially parallel” as used herein means the same as or very close to parallel and includes features or axes that are within ±3° of being parallel each other. As is best shown in FIG. 2, the axis 110 may be disposed below the differential axis 80.

Referring primarily to FIGS. 1 and 4, the transmission 28, if provided, facilitates the transmission of torque between the torque source 26 and a drive pinion 30. Torque transmission may be bidirectional. The transmission 28 may provide gear reduction and multiple gear ratios between the rotor 102 and the drive pinion 30. The transmission 28 may be of any suitable type. For instance, the transmission 28 may be a countershaft transmission, an epicyclic transmission (e.g., a transmission having a planetary gear set), or the like. A countershaft transmission may include a single countershaft or multiple countershafts. Examples of an axle assembly having a single countershaft transmission are disclosed in U.S. Pat. Nos. 11,002,352 and 11,209,072. Examples of an axle assembly having a dual countershaft transmission is disclosed in in U.S. Pat. Nos. 10,989,288, 11,207,976, and 11,220,176. Examples of an axle assembly having an epicyclic transmission are disclosed in U.S. Pat. Nos. 11,038,396 and 11,428,297. The disclosures of the references in the preceding three sentences are hereby incorporated in their entirety by reference herein.

A portion of a transmission 28 that is configured as a dual countershaft transmission is shown in FIGS. 3 and 4. In such a configuration, the transmission 28 includes sets of gears. For instance, the transmission 28 may include a set of drive pinion gears that may be rotatable about the axis 110, a first countershaft gear set, and a second countershaft gear set. Gears of the first and second countershaft gear sets may be disposed on and rotatable with first and second countershafts, respectively. The second countershaft gear set may be omitted in a single countershaft configuration. Each countershaft gear may mesh with a corresponding drive pinion gear. One or more drive pinion gears may be selectively coupled to the drive pinion 30, such as with a clutch, to transmit torque at a desired gear ratio.

Referring primarily to FIG. 4, the drive pinion 30 is operatively connectable to differential assembly 22 and the torque source 26. For instance, the drive pinion 30 may help operatively connect the transmission 28 to the differential assembly 22. As such, the drive pinion 30 may help transmit torque between the differential assembly 22 and the transmission 28. The drive pinion 30 is rotatable about the axis 110. The drive pinion 30 is disposed inside the housing assembly 20. In some configurations, the drive pinion 30 at least partially disposed inside the differential carrier 42 and may be rotatably supported on the differential carrier 42 via one or more roller bearing assemblies. The drive pinion 30 may have a shaft portion 120 and a gear portion 122.

The shaft portion 120 extends along the axis 110. The shaft portion 120 is operatively connectable to the transmission 28. For instance, the shaft portion 120 may be selectively coupled to a transmission gear, such as a drive pinion gear, with a clutch, shift collar, or the like. In the configuration shown, the shaft portion 120 includes multiple segments that are assembled to each other and rotatable together about the axis 110. The shaft portion 120 may extend through an opening 130 in the differential carrier 42 to facilitate coupling to the drive pinion brake 36.

The gear portion 122 extends from the shaft portion 120 and is rotatable about the axis 110 with the shaft portion 120. In some configurations, the gear portion 122 is positioned along the axis 110 between the torque source 26 and the drive pinion brake 36. As such, the gear portion 122 does not mesh with the ring gear 90 of the differential assembly 22. The gear portion 122 includes a plurality of teeth that mate or mesh with corresponding teeth on another component, such as the intermediate shaft 32. The gear portion 122 may be integrally formed with the shaft portion 120 or may be provided as a separate component that may be fixedly disposed on the shaft portion 120.

Referring primarily to FIG. 5, the intermediate shaft 32 operatively connects the drive pinion 30 and the differential assembly 22. As such, the intermediate shaft 32 may transmit torque between the drive pinion 30 and the differential assembly 22. The intermediate shaft 32 is disposed inside the housing assembly 20. For instance, the intermediate shaft 32 may be disposed inside the differential carrier 42 and may be rotatably supported on the differential carrier 42. The intermediate shaft 32 may be rotatable about an intermediate shaft axis 140. The intermediate shaft axis 140 is offset from the differential axis 80 and the axis 110. For instance, the intermediate shaft axis 140 may not intersect the differential axis 80 and the axis 110. The intermediate shaft axis 140 may be disposed substantially parallel to the differential axis 80, the axis 110, or both. The term “substantially parallel” as used herein means the same as or very close to parallel and includes features or axes that are within ±3° of being parallel each other. In some configurations and as is best shown in FIG. 2, the intermediate shaft axis 140 may be disposed above the differential axis 80, the axis 110, or both. As is best shown in FIG. 5, the intermediate shaft 32 may include a first intermediate gear 142 and a second intermediate gear 144.

The first intermediate gear 142 meshes with the gear portion 122 of the drive pinion 30. In some configurations, the first intermediate gear 142 may be positioned along the intermediate shaft axis 140 further from the torque source 26 than the second intermediate gear 144.

The second intermediate gear 144 is rotatable about the intermediate shaft axis 140 with the first intermediate gear 142. The second intermediate gear 144 meshes with the ring gear 90 of the differential assembly 22.

Referring to FIG. 1, one or more wheel brake assemblies 34 may be provided with the axle assembly 10. In the configuration shown, two wheel brake assemblies 34 are illustrated with each wheel brake assembly 34 being mounted on a corresponding arm portion 52 of the axle housing 40. The wheel brake assembly 34 is operable to brake a corresponding wheel and wheel hub 12. The wheel brake assembly 34 may be of any suitable type, such as a dry brake like a drum brake or a disc brake, or a wet brake such as a wet disc brake that may include multiple brake discs that are mounted within a brake housing along with a fluid like oil or transmission fluid that helps lubricate and cool the brake discs. In FIG. 1, the wheel brake assembly 34 is depicted as a wet brake. The wheel brake assembly 34 may be actuated in any suitable manner, such as being hydraulically actuated, electrically actuated, or the like. The wheel brake assemblies 34 differ from the drive pinion brake 36.

Referring primarily to FIGS. 1 and 4, the drive pinion brake 36 is operable to provide or apply a brake torque that inhibits rotation of the drive pinion 30 about the axis 110. Brake torque that inhibits rotation of the drive pinion 30 about the axis 110 may also inhibit rotation of the differential assembly 22 about the differential axis 80, inhibit rotation of the intermediate shaft 32 about the intermediate shaft axis 140, or both. Such brake torque may also inhibit rotation of both wheel hubs 12 as contrasted with a wheel brake assembly 34 which may brake a single associated wheel hub 12.

The drive pinion brake 36 is mounted to the differential carrier 42. In addition, the drive pinion brake 36 may be disposed outside of the differential carrier 42. The drive pinion brake 36 is spaced apart from and is not mounted to the axle housing 40. In at least one configuration, the drive pinion brake 36 and the torque source 26 may be positioned on opposite sides of the differential carrier 42. As such, the differential carrier 42 may be axially positioned or positioned along the axis 110 between the torque source 26 and the drive pinion brake 36.

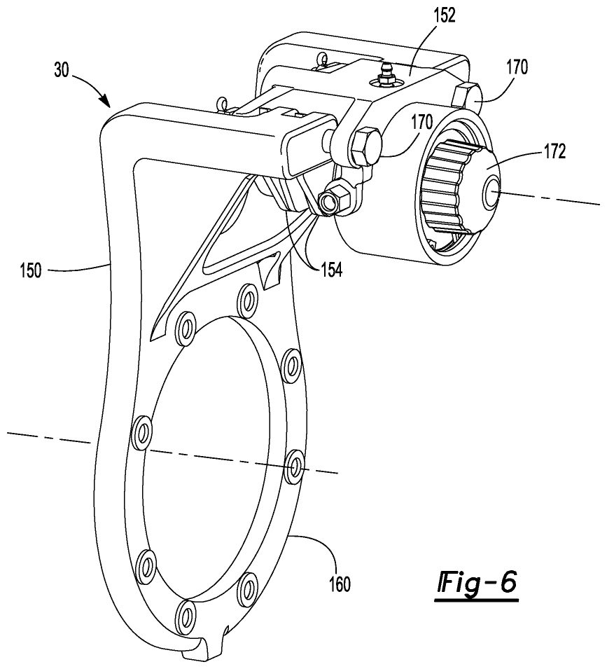

The drive pinion brake 36 may be of any suitable type. For instance, the drive pinion brake 36 may be configured as a disc brake, drum brake, clutch such as a disc clutch, or the like. The drive pinion brake 36 will primarily be described below in the context of a disc brake, an example of which is shown with reference to FIG. 6. In such a configuration, the drive pinion brake 36 may include a brake carrier 150, a brake caliper 152, and one or more friction members 154. As is best shown in FIGS. 3-5, a rotatable braking component 156 may be associated with the drive pinion brake 36.

Referring primarily to FIGS. 3, 5, and 6, the brake carrier 150 facilitates mounting of the drive pinion brake 36. For instance, the brake carrier 150 may be fixedly mounted to the differential carrier 42. In some configurations, the brake carrier 150 may have a mounting ring 160 that may at least partially encircle the axis 110 and that may be attached to the differential carrier 42 with fasteners, such as bolts. The brake carrier 150 may receive and support the friction members 154. In at least one configuration, the brake carrier 150 may straddle the rotatable braking component 156 and may help position friction members 154 on opposite sides of the rotatable braking component 156.

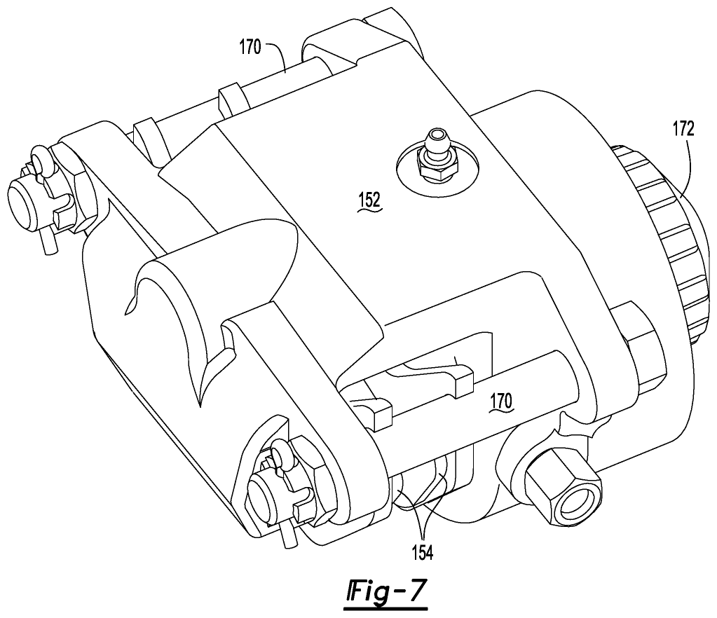

Referring primarily to FIGS. 5-7, the brake caliper 152 helps position the friction members 154 with respect to the rotatable braking component 156 to facilitate application of brake torque. The brake caliper 152 is moveably disposed on the brake carrier 150. For example, the brake caliper 152 may be slidable along a pair of guide pins 170 that may be mounted to the brake carrier 150. An actuator 172 may be disposed on the brake caliper 152 and may actuate the brake caliper 152 with respect to the brake carrier 150. In some configurations, the actuator 172 is configured to actuate a friction member 154 that is disposed adjacent to or closest to the actuator 172 into engagement with the rotatable braking component 156. A reaction force may then move the brake caliper 152 with respect to the brake carrier 150 to actuate a friction member 154 that is disposed on the opposite side of the rotatable braking component 156 into engagement with an opposite side of the rotatable braking component 156 to help slow rotation of the rotatable braking component 156.

A friction member 154 is engageable with a friction surface 180 of the rotatable braking component 156 to provide brake torque to slow or stop rotation of the rotatable braking component 156. In a disc brake configuration, the friction members 154 may be configured as brake pad assemblies that may be supported by in the brake carrier 150 or the guide pins 170 and that may be disposed on opposite sides of the rotatable braking component 156 that is configured as a brake rotor. In such a configuration, a friction member 154 may include friction material that is disposed on a backplate. The friction material engages the rotatable braking component 156 during braking and may be spaced apart from the rotatable braking component 156 when braking is not provided. As is best shown in FIG. 2, the friction members 154 may be positioned further from the differential axis 80 than the axis 110 is positioned from the differential axis 80 or further to the left from the perspective shown. In addition, the friction member 154 may be disposed above the axis 110.

Referring primarily to FIG. 4, the rotatable braking component 156 may be disposed outside of the housing assembly 20. The rotatable braking component 156 may have any suitable configuration. For example, the rotatable braking component 156 may be a brake rotor in a disc brake configuration and may be a brake drum in a drum brake configuration. In some configurations, the rotatable braking component 156 may be rotatable with the drive pinion 30. For instance, the rotatable braking component 156 may be fixedly mounted to the shaft portion 120 of the drive pinion 30 and may be rotatable about an axis 110 with the drive pinion 30.

The drive pinion brake 36 may be actuated in any suitable manner. For instance, the drive pinion brake may be actuated with an electrical actuator, electromechanical actuator, hydraulic actuator, mechanical actuator, or the like. The drive pinion brake 36 may provide brake torque when power is not provided to the brake actuator (e.g., braking torque is provided when the brake actuator is off and powering the brake actuator terminates braking). Thus, the drive pinion brake 36 may help hold the vehicle in a stationary position, such as when the vehicle is parked or turned off and propulsion torque is not provided.

An axle assembly as described above may provide braking functionality with a drive pinion brake that operable independent of the wheel brake assemblies that are configured to brake a single wheel hub. As such, parking brake functionality may be provided when the wheel brake assemblies or an associated wheel brake actuator is inoperative, such as may be the case when the vehicle is turned off or when the wheel brake assemblies are not configured to provide parking brake functionality, such as may be the case with hydraulically actuated wheel brake assemblies. As such, parking brake functionality may be provided independent of operation of a power source for a wheel brake actuator. Providing parking brake functionality may inhibit movement of the vehicle when a torque source is turned off or is inactive. In a configuration in which the torque source is an electric motor, the drive pinion brake may be used to inhibit vehicle movement rather than by providing braking with the electric motor, which may help reduce energy consumption and avoid overheating of the electric motor. A single drive pinion brake may provide parking brake functionality and may do at a lower cost or with lower energy consumption than a parking brake that is disposed at or near the wheel hub.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. An axle assembly comprising:
a differential carrier;
a differential assembly that rotatably mounted to the differential carrier, wherein the differential assembly is rotatable about a differential axis;
a drive pinion that is rotatable about a drive pinion axis that differs from the differential axis, wherein the drive pinion is operatively connectable to the differential assembly; and
a drive pinion brake that is mounted to the differential carrier, wherein the drive pinion brake is operable to apply a brake torque that inhibits rotation of the drive pinion about the drive pinion axis and wherein the drive pinion axis is disposed below the differential axis.

2. The axle assembly of claim 1 wherein the brake torque inhibits rotation of the differential assembly.

3. The axle assembly of claim 1 wherein the differential axis is disposed substantially parallel to the drive pinion axis and does not intersect the drive pinion axis.

4. (canceled)

5. The axle assembly of claim 1 further comprising an axle housing that is mounted to the differential carrier, wherein the axle housing and the differential carrier cooperate to define a cavity inside which the differential assembly is disposed, wherein the drive pinion brake is not mounted to the axle housing.

6. The axle assembly of claim 1 wherein the differential assembly further comprises a ring gear, the drive pinion further comprises a gear portion, and the gear portion does not mesh with the ring gear.

7. The axle assembly of claim 6 wherein the axle assembly further comprises an intermediate shaft that is rotatable about an intermediate shaft axis, wherein the intermediate shaft further comprises a first intermediate gear that meshes with the drive pinion and a second intermediate gear that meshes with the ring gear.

8. The axle assembly of claim 7 wherein the intermediate shaft is rotatably supported on the differential carrier.

9. The axle assembly of claim 7 wherein the intermediate shaft axis does not intersect the differential axis and the drive pinion axis.

10. The axle assembly of claim 1 wherein the drive pinion brake is disposed outside the differential carrier.

11. The axle assembly of claim 1 wherein the drive pinion brake further comprises a rotatable braking component that is rotatable about the drive pinion axis with the drive pinion, the rotatable braking component further comprising a friction surface.

12. The axle assembly of claim 11 wherein the drive pinion brake further comprises a friction member that is engageable with the friction surface to provide the brake torque.

13. The axle assembly of claim 12 wherein the friction member is positioned further from the differential axis than the drive pinion axis is positioned from the differential axis.

14. The axle assembly of claim 12 wherein the friction member is disposed above the drive pinion axis.

15. The axle assembly of claim 11 wherein the drive pinion brake is configured as a disc brake and the rotatable braking component is a brake rotor.

16. The axle assembly of claim 11 wherein the drive pinion further comprises a shaft portion that extends through an opening in the differential carrier.

17. The axle assembly of claim 16 wherein the rotatable braking component is mounted to the shaft portion.

18. The axle assembly of claim 1 wherein the drive pinion is operatively connectable to a torque source.

19. The axle assembly of claim 18 wherein the torque source is an electric motor.

20. The axle assembly of claim 19 wherein the drive pinion further comprises a gear portion, the gear portion being positioned along the drive pinion axis between the electric motor and the drive pinion brake.

21. An axle assembly comprising:
a differential carrier;
a differential assembly that rotatably mounted to the differential carrier, wherein the differential assembly is rotatable about a differential axis;
a drive pinion that is rotatable about a drive pinion axis that differs from the differential axis, wherein the drive pinion is operatively connectable to the differential assembly; and
a drive pinion brake that is mounted to the differential carrier, wherein the drive pinion brake is operable to apply a brake torque that inhibits rotation of the drive pinion about the drive pinion axis and the drive pinion brake is disposed farther from the differential axis than the differential carrier.

22. An axle assembly comprising:
a differential carrier;
a differential assembly that rotatably mounted to the differential carrier, wherein the differential assembly is rotatable about a differential axis;
a drive pinion that is rotatable about a drive pinion axis that differs from the differential axis, wherein the drive pinion is operatively connectable to the differential assembly; and
a drive pinion brake that is mounted to the differential carrier, wherein the drive pinion brake comprises a brake caliper and is operable to apply a brake torque that inhibits rotation of the drive pinion about the drive pinion axis, wherein the drive pinion axis and differential axis are positioned below the brake caliper and the drive pinion brake is disposed farther from the differential axis than the differential carrier.

23. The axle assembly of claim 1 wherein the differential carrier is part of a housing assembly and the drive pinion brake is completely disposed outside the housing assembly.
